(19) United States
(12) Patent Application Publication
(10) Pub. No.: US 2025/0209060 A1
(43) Pub. Date: Jun. 26, 2025

(54) LOCATION-BASED CONTENT MANAGEMENT METHOD FOR OUTPUTTING DIGITAL CONTENT TO A USER, AND LOCATION-BASED CONTENT MANAGEMENT SYSTEM

(71) Applicant: ETO GRUPPE TECHNOLOGIES GMBH, Stockach (DE)

(72) Inventor: Benjamin BÖNISCH, Bodman-Ludwigshafen (DE)

(21) Appl. No.: 18/849,021

(22) PCT Filed: Mar. 21, 2023
(86) PCT No.: PCT/EP2023/057137

§ 371 Date: Dec. 16, 2024

(30) Foreign Application Priority Data
Mar. 24, 2022 (DE) 10 2022 107 027.1

(51) Int. Cl. G06F 16/23; G06F 16/9537

(52) U.S. Cl. CPC G06F 16/2379; G06F 16/9537

(57) ABSTRACT

A location-based, preferably decentralized, content management method at least for outputting digital contents to a user, has at least the method steps
determining a location of the user
identifying a digital content virtually arranged in the region of the location of the user
providing the digital content for retrieval to the user, wherein the digital content is provided via at least one smart contract set up on a, preferably decentralized, digital ledger technology (DLT), such as e.g. a blockchain or a tangle.

### CROSS-REFERENCE TO RELATED APPLICATION

This patent application is a U.S. national stage application of international patent application PCT/EP2023/057137, filed on Mar. 21, 2023, which is based on and claims priority to German patent application DE 10 2022 107 027.1, filed on Mar. 24, 2022, the contents of which are incorporated herein by reference.

### PRIOR ART

The invention relates to a method, a further method and a system. Augmented reality systems based on interaction with a central server or a cloud have already been proposed.

### SUMMARY

The object of the invention is in particular to provide a generic device having advantageous properties with regard to versatility and/or user-friendliness. The object is achieved according to the invention.

The invention is based on a, in particular computer-implemented, location-based, preferably decentralized, content management method at least for outputting digital contents (content) to a user, comprising at least the method steps: a) determining a location of the user; b) identifying a digital content virtually arranged in the region of the location of the user; and c) providing the digital content, in particular virtually arranged in the region of the location of the user, for retrieval to the user, in particular at least for the period in which the digital content is located in the region of the location of the user.

It is proposed that the digital content is provided via at least one smart contract set up on a, preferably decentralized, digital ledger technology (DLT), such as e.g. a blockchain or a tangle. As a result, particularly high versatility can advantageously be achieved, in particular by a multiplicity of individually adapted smart contracts being able to be used. In addition, high user-friendliness can advantageously be achieved, in particular by particularly high transparency with regard to the origin of contents and/or with regard to remuneration streams being able to be achieved, in particular when the smart contract is set up on a public, preferably distributed, DLT. In addition, decentralization can advantageously be achieved, as a result of which a susceptibility to system failures can advantageously be reduced. A direct implementation of a content management method can advantageously be achieved, which is free of intermediaries, in particular in the remuneration of services and/or in the sharing of contents. As a result, high efficiency, in particular cost efficiency and/or energy efficiency, can advantageously be achieved. Secure direct interactions/transactions between parties which do not know one another and accordingly have not yet established trust with one another can advantageously be made possible, in particular by the use of smart contracts. As a result, an intermediary, such as a bank or a database manager, can advantageously be dispensed with. There is advantageously no need for agreements or associated contractual obligations between the participants of the content management method.

In a location-based content management method, in particular contents are managed, that is to say provided, for example, which are linked, in particular virtually, to a location coordinate. The content management method is preferably also configured for an addition of digital contents in a content management system (CMS). A digital content can be embodied as a digital image file, a digital video file, a digital sound file, a digital character string, a digital key, a digital computer program (app) or the like. In particular, the content management method is configured for providing the digital content in such a way that it can be played by a playback device of the user. The location of the user can be determined by means of a locating function of the playback device of the user or of a further device of the user, for example an interface device of the user. For example, global locating using navigation satellite systems, such as GPS, etc., or local locating using locating methods independent of navigation satellite systems, such as local triangulation with anchor stations, e.g. via ultra-wideband (UWB) signals, or the like or a local time-of-flight measurement, etc., are conceivable. The determination of the digital contents virtually arranged in the region of the location of the user can be carried out via a comparison of the location/location coordinate currently determined for the user with the respective location coordinates which are assigned to the digital contents, in particular of the CMS. The region can be fixed variably in this case. Meaningful region sizes can be formed, for example, by circles with diameters of between 0.5 m and 10 m (e.g. 0.5 m, 1 m, 1.5 m, 2 m, 2.5 m, 3 m, 4 m, 5 m, 6 m, 7 m, 8 m, 9 m, 10 m) around the currently determined location of the user. For certain applications, such as city tours, for example, even much larger regions of several 10 m or even 100 m are conceivable. If one or more digital contents are now found in the fixed region, they can be displayed to the user for selection, e.g. in a dropdown menu of data glasses. Digital contents which are displayed to the user for selection can be played by the user at the location at which the user is currently located. In this case, it is conceivable for the digital contents to be removed again from the selection made available to the user if the user moves away from the location coordinate of the digital content, in particular if the digital content is no longer located in the location-altered region of the location of the user. Alternatively, it is conceivable for the user to “collect” all the digital contents which were once located in the region of the location of the user and to provide them for a later, possibly temporally limited, retrieval. In addition, it is conceivable for the digital contents to be ranked or to be displayed in a ranked manner. For example, the digital contents can be displayed sorted as a function of user ratings, e.g. a number of “likes” or a score awarded by users. In particular, higher-ranked digital contents could be displayed in a preferred manner or in an enlarged manner or in a specially marked manner.

The fact that the digital content is provided via a smart contract is to be understood in particular as meaning that the user interacts with a smart contract before the digital content is called up or played back. In this case, a smart contract can organize/manage the provision of a plurality of digital contents or a separate, in particular individual, smart contract can be assigned to each digital content or subsets of all the digital contents. In particular, a result of the interaction with the smart contract decides whether or not the digital content is provided for use by the user. The smart contract is preferably set up on a DLT which is based on a directed acyclic graph architecture (DAG), such as IOTA™, for example. The smart contract is advantageously set up on a DLT which is free or virtually free of transaction costs. The smart contract is advantageously set up on a DLT which is at least substantially free of a limitation of a transaction throughput. Alternatively, however, other DLTs are also conceivable, e.g. smart contract-capable blockchains such as Ethereum, EOS, Stellar, Solana, Avalanche, Fantom, Cronos, Polygon, Algorand, Chainlink, Binance Smart Chain, etc. The smart contract is advantageously publicly visible and unalterable as a result of being set up on the DLT.

A “smart contract” is to be understood in particular as meaning a contract which is set up on the DLT and comprises at least one, preferably a plurality of if/then conditions as preprogrammed functions which can be called up. For this purpose, in particular “if” conditions are provided as input to the smart contract and the smart contract reacts by an output/non-output of “then” results. In particular, the smart contract is embodied as a software code which is set up on the DLT. In particular, the smart contract is embodied as unalterable as a result of being set up on the DLT. In particular, a DLT address in the DLT is assigned to the smart contract. In particular, the smart contract can be called up by virtue of transactions being sent to the DLT address of the smart contract (“write”). In particular, execution of the smart contract can require payment of a fee which is added to the transactions which call up the smart contract in the form of DLT tokens of the DLT. In particular, the smart contract is executed after more than one DLT node (“quorum”) of the DLT has been called up, wherein the result is output only when all members of the quorum arrive at the same result. After receiving a DLT transaction which is triggered by the user, the smart contract preferably executes the following steps: a) verifying the existence of the functions in the smart contract which are to be called up according to the information received with the DLT transaction, possibly with a plausibility check of the parameters, b) verifying whether sufficient fees have been received in the form of DLT tokens, possibly surplus fees are sent back, c) preparing a transaction at one or more DLT addresses of the DLT network, in particular at least at the DLT address from which the smart contract has been called up, wherein the transaction comprises an authorization to access the digital content or the digital content (possibly as a non-fungible token, NFT) itself, and d) executing the transaction. If the digital content is embodied as an NFT, then the DLT address to which the transaction was directed is then the DLT owner address of the new NFT. The DLT owner address is assigned to the entity (here: the user) which knows/owns the private key associated with the DLT address (generally itself a public key of the DLT, e.g. 0xEfcA6C6981a448388780cbfefA72dc77C3F73e6b). As a result, the entity is in particular able to forward all DLT tokens, NFTs, etc., which are assigned to the DLT owner address, within the DLT. “Configured” is to be understood in particular as meaning specially programmed, designed and/or equipped. The fact that an object is configured for a certain function is to be understood in particular as meaning that the object performs and/or executes this certain function in at least one application state and/or operating state.

Furthermore, it is proposed that, in particular in a request step, a desire to retrieve the digital content is announced by sending a DLT transaction to a write function of the smart contract, in particular by means of the interface device assigned to the user. As a result, a direct provision of the digital contents substantially free of intermediaries can advantageously be made possible. For example, in the request step, a request is sent by a device assigned to the user, e.g. the interface unit, to the smart contract to provide a certain previously selected digital content (e.g. the content #2145) to a holder of a certain DLT address (e.g. 0xEfcA6C6981a448388780cbfefA72dc77C3F73e6b). In this case, the DLT transaction is sent in particular directly by the device assigned to the user to the smart contract in the DLT. In this case, the DLT transaction preferably comprises a plurality of input parameters/call parameters/digital assets, e.g. the identifier of the desired digital content and the DLT addresses for which the digital content is requested, or additional information about restrictions in the reproduction/specifications for the reproduction of the digital content, such as e.g. language, age of the user, advertising permission, advertising preference, approval of use conditions, detail level of the released digital content, etc. If the DLT is not free of transaction costs, the DLT transaction also comprises a so-called “gas fee” or the DLT transaction sent to the write function of the smart contract is signed by the user who wishes to retrieve the digital content. As a result, high security of the transactions can advantageously be achieved.

In addition, it is proposed that at least one digital asset, such as e.g. a message, information or a DLT token, is appended to the DLT transaction to the write function, in particular in addition to the call parameters for the write function. As a result, interaction between the partners of the smart contract can advantageously be specified and/or optimized. For example, a released content can advantageously be adapted to frame parameters desired by the user. For example, digital contents can be released in different languages, with different detail levels, for different age groups, with different advertising admixtures, etc.

The user can advantageously make a corresponding selection when calling up the write function(s) of the smart contract. In this case, it is additionally conceivable for different outputs of the digital content to be associated with different fees. The user can already append the corresponding fees in the form of DLT tokens to the transaction to the write function, which fees are then distributed by the smart contract to the corresponding authorized recipients. The DLT tokens can be embodied as cryptocurrency tokens to which a monetary value is assigned, as NFTs, as incentive tokens/rating points of a rating and/or reputation system, as voucher tokens, or as other types of DLT tokens.

Furthermore, it is proposed that a release of the digital content is at least triggered by a DLT response transaction of the smart contract. As a result, a direct provision of the digital contents substantially free of intermediaries can advantageously be made possible. For example, a key for decrypting the digital content can be included in the DLT response transaction. For example, the DLT response transaction can contain a discovery and/or download address for the digital content. For example, the DLT response transaction can contain the digital content directly. For example, the DLT response transaction can be sent to the DLT or to a department storing the digital content, which permits an owner of a certain DLT address (e.g. the DLT address of the user) access to the digital content. Further release types known to the person skilled in the art, which in particular can also be specifically restricted only to owners of certain DLT addresses, are of course conceivable. In addition, it is conceivable for the DLT response transaction to include a temporal limitation of the release of the digital content. The temporal limitation could in this case be embodied as a type of countdown until the end of the release, as a fixed end time of the release or as a dynamic limitation dependent on at least one further external condition (e.g. a presence of digital assets on a cryptowallet which is assigned to the DLT address to which the release also applies).

However, it is preferably proposed that the digital content is released specifically for at least one interface device to which a DLT receive address of the DLT response transaction is assigned or to which a DLT address is assigned which is specified in the DLT response transaction. As a result, a secure direct and targeted provision of the digital content can advantageously be achieved. It is conceivable for a plurality of addresses of different interface devices to be specified in the DLT response transaction or for a plurality of DLT response transactions to be sent to different interface devices in response to calling up the write function. The interface device can be embodied as a playback device for digital contents, such as a smartphone or data glasses, but the playback device is preferably embodied differently from a, in particular usual, playback device for digital contents, which, however, in particular has a communication interface for communicating the digital contents and/or the release to one or more playback devices.

Furthermore, it is proposed that the DLT response transaction is flanked by at least one, in particular automatic, DLT response accompanying transaction, in particular of the smart contract, which comprises at least sending and/or forwarding at least one digital asset, such as e.g. a message, an information or a DLT token, to at least one third-party DLT address, in particular not assigned to the user with the desire to retrieve. As a result, a particularly advantageous, in particular simple, flexible and/or secure, administration for content management systems can be made possible. In particular, it is specified in the smart contract when which DLT response accompanying transaction is sent with which content. For example, at least some of the digital assets, e.g. the DLT tokens, which were appended to the DLT transaction originally sent to the write function, can be forwarded by one or more of the DLT accompanying transactions. As a result, a reliable, manipulation-secure and comprehensible distribution of the digital assets can advantageously be made possible. Alternatively, the flanking DLT response accompanying transactions could not take place automatically, but only at the request of the recipient of the release. For example, the recipient could manually trigger one or more flanking DLT response accompanying transactions as a function of satisfaction with the transmission service and/or with the received digital content. For example, a flanking DLT response accompanying transaction could be triggered by an assignment of a “like” for the digital content or as a function of a rating of the digital content by the recipient (the better the rating, the more DLT tokens are sent). In particular, the flanking DLT response accompanying transactions are triggered by the smart contract. Alternatively or additionally, an optional direct triggering of the flanking DLT response accompanying transactions by the user, e.g. during the “like” assignment, is also conceivable. The forwarded digital asset is part of the digital asset originally transmitted to the write function.

If at least one third-party DLT address which is the target of at least one DLT response accompanying transaction is assigned to an originator of at least a part of the digital content, an advantageous (secure, reliable, uncomplicated and/or direct), in particular permanent, inclusion of the originator, preferably all originators, in the distribution and administration of digital contents can be made possible. In particular, it is conceivable for the originator to have to issue a confirmation, e.g. by a signature registered in the DLT, before the release is issued. In this way, a user circle can be fixed in a simple manner. In particular, a digital content can have a plurality of originators which can each be targets of different DLT response accompanying transactions. The smart contract can advantageously be used to fix to which originator, i.e. to which third-party DLT address, what and how much of it is forwarded.

If alternatively or additionally at least one third-party DLT address which is the target of at least one DLT response accompanying transaction is assigned to an administrator and/or a provider of the digital content, an advantageous (secure, reliable, uncomplicated and/or direct), in particular permanent, inclusion of the administrator and/or provider in the distribution and administration of digital contents can be made possible. In particular, it is conceivable for the administrator and/or provider to receive feedback on a popularity/frequency of use of digital contents as a result. In particular, it is conceivable for the administrator and/or provider to receive participation in the total quantity of DLT tokens sent by the user as a result. The smart contract can advantageously be used to fix to which administrator and/or which provider, i.e. to which third-party DLT address, what and how much of it is forwarded.

If alternatively or additionally at least one third-party DLT address which is the target of at least one DLT response accompanying transaction is assigned to an owner and/or producer of the devices which can be assigned to the users, in particular the interface devices, an advantageous (secure, reliable, uncomplicated and/or direct), in particular permanent, inclusion of the owner and/or the producer of the devices which can be assigned to the users in the distribution and administration of digital contents can be made possible. In particular, it is conceivable for the owner and/or the producer of the devices which can be assigned to the users to receive feedback on a popularity/frequency of use of the devices, in particular the interface devices, as a result. In particular, it is conceivable for the owner and/or the producer of the devices which can be assigned to the users to receive participation in the total quantity of DLT tokens sent by the user as a result. The smart contract can advantageously be used to fix to which owner and/or producer of the devices which can be assigned to the users, i.e. to which third-party DLT address, what and how much of it is forwarded.

Furthermore, it is proposed that at least one third-party DLT address which is the target of at least one DLT response accompanying transaction is assigned to at least one further smart contract. As a result, particularly high flexibility and/or expandability of the content management system can be achieved, in particular despite the static immutability of smart contracts embedded in the DLT. A linking of smart contracts can advantageously be achieved as a result. The further smart contract could be, for example, the smart contract of an original digital content which was used in the creation of the currently requested digital content. This further smart contract can then again provide a distribution, e.g. to the originator of the aforementioned original digital content. The distribution of digital assets undertaken by the further smart contract could be changed as a function of the origin of the DLT response accompanying transaction or as a function of a popularity of a reused digital content in accordance with its popularity, etc. For example, the further smart contract could be designed such that, for a positive response from the further smart contract to the smart contract with each reuse of a digital content in another digital content, a higher proportion of the digital assets is required when calling up the write function of the smart contract. In particular, the smart contract could be designed such that, in order to grant the release, firstly all further smart contracts of reused digital contents themselves must have sent a release to the smart contract.

If a write function of the further smart contract is executed by the DLT response accompanying transaction, an expandable chain of smart contracts can advantageously be obtained for the administration of releases of digital contents. Particularly high flexibility can advantageously be achieved as a result.

In addition, it is proposed that, in particular in a submitting step, a desire to submit a digital content which is provided for retrieval, in particular after the submitting, is announced by sending a DLT transaction to a further write function of the smart contract or of a further smart contract which is likewise set up on the digital ledger technology (DLT), in particular by means of an, in particular further, interface device assigned to an originator and/or submitter. As a result, a direct provision of the digital contents substantially free of intermediaries between originator/submitter and consumer/user can advantageously be made possible. In particular, the same smart contract is used for the submitting and for the retrieval of the digital contents. Alternatively, however, different smart contracts can also be configured for the submitting and for the retrieval of the digital contents. For example, in the submitting step, a request is sent by a device assigned to the originator/submitter, e.g. a further interface unit, which can be embodied in particular identically to the interface unit, to the smart contract to register a certain previously selected digital content in the DLT or to send it to the DLT. A content number (e.g. content #2145) is then assigned to the content, in particular by the smart contract. Under this content number, the digital content can be requested later by a user. In this case, the DLT transaction is sent in particular directly by the device assigned to the originator/submitter to the smart contract in the DLT. In this case, the DLT transaction preferably comprises a plurality of input parameters/call parameters/digital assets, e.g. the type and/or the extent of the desired digital asset which is intended to be forwarded to the originator/submitter when the digital content is called up, and the DLT addresses to which the digital asset is intended to be forwarded or further additional information about restrictions in the release/specifications for the release of the digital content, such as e.g. language, age of the permitted users, use conditions, etc.

If the provided digital contents are linked to a non-fungible token (NFT) of the DLT, high forgery security can advantageously be achieved. In addition, a controlled forwarding of the digital contents by users to further users can advantageously be made possible. If the digital contents are distributed as NFTs, they can advantageously be fixedly connected to certain DLT addresses. The forwarding of such NFTs could also be organized via the smart contract or a further smart contract. For example, during each forwarding of the NFT, so-called royalties in the form of digital assets can be branched off via the smart contract and distributed to the originator and/or the creator of the digital content or to previous owners of the NFT.

If at least some of the provided digital contents are stored in a decentralized manner, for example in the DLT, a particularly manipulation-secure, direct organization that manages without intermediaries and/or is lean can advantageously be achieved. Alternatively, the digital contents can be stored at least partially centrally on a server or in a cloud. In particular, the storage location could be made dependent on a file size of the digital content. Everything above a specific file size limit would then be stored centrally, whereas everything below the file size limit is stored in a decentralized manner on the DLT.

In addition, a (further) location-based, preferably decentralized, content management method at least for a spatially organized addition of digital contents which are made available by originators (20) and/or creators in a location-based, in particular decentralized, content management system (CMS) is proposed, wherein a real three-dimensional addition space for the digital contents is divided virtually into a multiplicity of volume segments which are arranged next to one another and one above the other, wherein each of the volume segments is assigned a bijective DLT address of a DLT, and wherein each of the digital contents is linked during the submitting to at least one of the DLT addresses assigned to one of the volume segments. As a result, a digital content, for example information, can advantageously be linked to a spatial component. The digital contents can advantageously be positioned spatially in three dimensions. A decentrally organized three-dimensional knowledge space can advantageously be created, which can be filled in particular with free knowledge created by anyone. In this case, a search by spatial information can advantageously be refined and/or improved. For example, the three-dimensional knowledge space comprising the spatial information could be searchable in a more targeted manner by intelligent AI search bots of the Web 4.0, since information is linked to spaces. If, for example, church lighting is searched for on the Internet today, an unmanageably large number of search results of really existing, really non-existing or earlier-existing illuminations will result. If an AI search bot now receives the task of displaying all currently viewable chandeliers in church ships which, if appropriate, also have similarities to a specific description, the AI search bot requires spatial information for the respective descriptions (digital contents). Such searches could additionally be delimited spatially or otherwise (“show me similar chandeliers in churches within a radius of 10 km”, “show me chandeliers from specific eras, from specific artists”, “show me chandeliers which are discussed by specific originators/creators of digital contents”, etc.). In particular, the volume segments can have different shapes, such as a cube shape, a shape of a hexagonal prism, a pyramid shape or another body shape with which a space can be filled without gaps. In particular, a digital content assigned, for example, to a particularly large object, such as, for example, a church window, can also be assigned to a plurality of volume segments, and thus in particular to a plurality of DLT addresses. These DLT addresses can then advantageously be inserted more easily into a smart contract, with the result that the smart contract can ultimately be found more easily if similar smart contracts are searched for by AI search bots.

In addition, it is proposed that each of the digital contents is linked to at least one smart contract placed on the DLT, wherein the digital content is made available to users via the at least one smart contract, preferably by means of the location-based content management method for outputting the digital contents to the user. As a result, high user-friendliness can advantageously be achieved, in particular by particularly high transparency with regard to the origin of contents and/or with regard to remuneration streams being able to be achieved. A direct implementation of a content management method can advantageously be achieved, which is free of intermediaries, in particular in the remuneration of services and/or in the sharing of contents.

If the real three-dimensional addition space is formed so as to span the globe, a particularly large amount of information can advantageously be achieved. For example, the three-dimensional addition space could be composed/constructed as follows. Firstly, the globe plus a height of approximately 10 km is inserted into a cube. This cube is then divided, for example, into 1 m×1 m×1 m subcubes. In the case of a diameter of the globe of approximately 12,756 km, the cube would then have a diameter of approximately 12,800 km and would have approximately 12,800×12,800×12,800×1,000=2,097, 152,000,000,000 subcubes. Subcubes which lie at unreachable locations below the earth's surface, that is to say, for example, subcubes within a globe diameter minus a depth of 10 km (in order to also be able to comprise underwater objects, cavities, etc.), then remained unconsidered and a bijective DLT address is then assigned to all other subcubes. As a result, approximately

2,097, 152,000,000,000-12,700×12,700×12,700×1,000=48,769,000,000,000 subcubes with DLT addresses would be obtained. In this example, these subcubes with DLT addresses then form the individual volume segments. In this example, the totality of all subcubes with DLT addresses then forms the three-dimensional addition space. Of course, three-dimensional addition spaces (e.g. delimited only to a building, such as a church) or three-dimensional addition spaces outside the earth (e.g. spanning the moon, etc.) are also conceivable. Of course, finer or coarser resolutions of the three-dimensional addition space in volume segments than the 1 cubic meter cubes are also conceivable. The volume segments of the three-dimensional addition space advantageously form a clean spatial search grid for AI search bots.

Furthermore, it is proposed that the DLT addresses assigned to the volume segments are additionally assigned to, in particular fixable, time intervals. As a result, a time component can advantageously additionally be added to the three-dimensional addition space. As a result, search calls can advantageously also be specified in terms of time (e.g. “what kind of chandelier was hanging here 10, 20 and 50 years ago”, “what kind of building stood here before?”). In particular, the DLT addresses assigned to the volume segments can be replaced by new DLT addresses in fixable time intervals or time intervals in the past, the present and/or the future are already assigned to all volume segments from the outset. As a result, proposals for the future could be stored in the CMS, for example. If, for example, something is broken at one location, a question could be: “what will happen here in the future?”. For example, an architect has then already stored a proposal in an audio file or an image file. The address space for DLT addresses of known DLTs is large enough for virtually any desired temporal resolutions (e.g. address space of Ethereum addresses: 2²⁵⁶>1.1e+77).

Furthermore, a location-based, in particular decentralized, content management system (CMS) is proposed, having at least one localization device for determining an instantaneous position of the user of the localization device, in particular for locating the user, and at least one interface device for communicating with the DLT. High user-friendliness can advantageously be achieved as a result, in particular by particularly high transparency with regard to the origin of contents and/or with regard to remuneration streams being able to be achieved. In addition, decentralization can advantageously be achieved, as a result of which a susceptibility to system failures can advantageously be reduced. A direct implementation of a content management method can advantageously be achieved, which is free of intermediaries, in particular in the remuneration of services and/or in the sharing of contents. As a result, high efficiency, in particular cost efficiency and/or energy efficiency, can advantageously be achieved. Secure direct interactions/transactions between parties which do not know one another and accordingly have not yet established trust with one another can advantageously be made possible, in particular by the use of smart contracts. The interface device can be embodied as a stand-alone electronic (computer) device which is preferably equipped with, in particular preinstalled, software which is provided at least for carrying out at least the request step and/or the submitting step of the above-described, in particular computer-implemented, location-based, preferably decentralized, content management method. In particular, the interface device is extensively described in a German patent application with the application number 10 2021 112 613.4, which is hereby incorporated in its entirety into the present patent application.

It is additionally proposed that the CMS has a content creation device which is formed differently from the localization device and differently from the interface device. The content creation device can be embodied as a smartphone, as a tablet, as data glasses, as a personal computer or as a further computer device which is preferably equipped with, in particular preinstalled, software which is configured at least for communicating digital contents with the interface device. The content creation device can optionally also be configured for carrying out at least the submitting step of the above-described, in particular computer-implemented, location-based, preferably decentralized, content management method.

Furthermore, it is proposed that the CMS has a content playback device which is formed differently from the localization device and differently from the interface device. The content playback device can be embodied as a smartphone, as a tablet, as data glasses, as a personal computer, as an audio reproduction device or as a further computer device which is preferably equipped with, in particular preinstalled, software which is provided at least for communicating digital contents with the interface device. The content playback device can optionally also be configured for carrying out at least the request step of the above-described, in particular computer-implemented, location-based, preferably decentralized, content management method.

If the content creation device is identical to the content playback device, simple operation and/or high user-friendliness can advantageously be achieved.

Alternatively, the content creation device and the content playback device could also be embodied as separate devices.

If, in addition, the localization device is identical to the interface device, simple operation and/or high user-friendliness can advantageously be achieved. Alternatively, the localization device and the interface device could also be embodied as separate devices. Alternatively, the localization device could also be integrated in a smartphone, that is to say embodied identically at least to the content playback device.

Furthermore, it is proposed that the CMS has one or more anchor stations which enable a determination, independent of navigation satellite systems, of a location of the user and/or of the virtually arranged digital contents, e.g. by local triangulation or by local time-of-flight measurements. As a result, a precise localization of the user within closed buildings and/or within regions in which no navigation satellite systems are available (e.g. cavities) can advantageously be made possible. A description of a mode of operation of a localization by means of anchor stations is described in the German patent application with the application number 10 2021 112 613.4.

The method according to the invention and the system according to the invention are not intended to be restricted here to the application and embodiment described above. In particular, the method according to the invention and the system according to the invention can have a number of individual elements, components and units differing from a number mentioned herein for fulfilling a mode of operation described herein.

### DRAWINGS

Further advantages result from the following description of the drawings. An exemplary embodiment of the invention is shown in the drawings. The drawings, the description and the claims contain numerous features in combination. The person skilled in the art will expediently also consider the features individually and combine them to form meaningful further combinations.

In the drawings:

FIG. 1 a schematic diagram of a location-based content management system (CMS),

FIG. 2 an exemplary interior application of the CMS,

FIG. 3 a schematic flow diagram of a location-based content management method and

FIG. 4 an exemplary three-dimensional addition space which is divided into volume segments.

### DETAILED DESCRIPTION

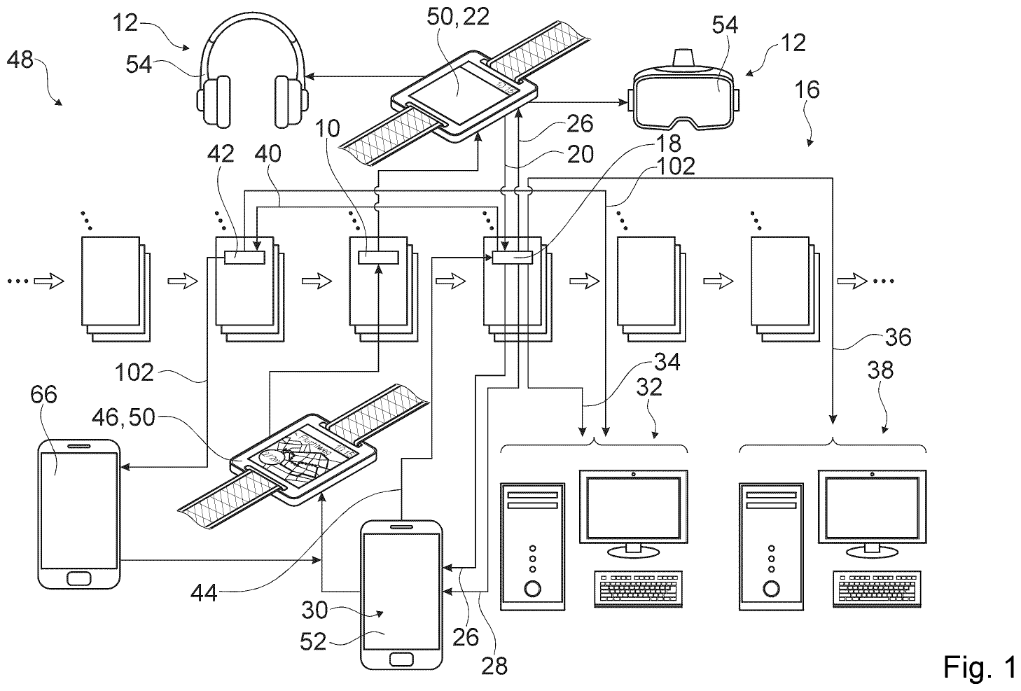

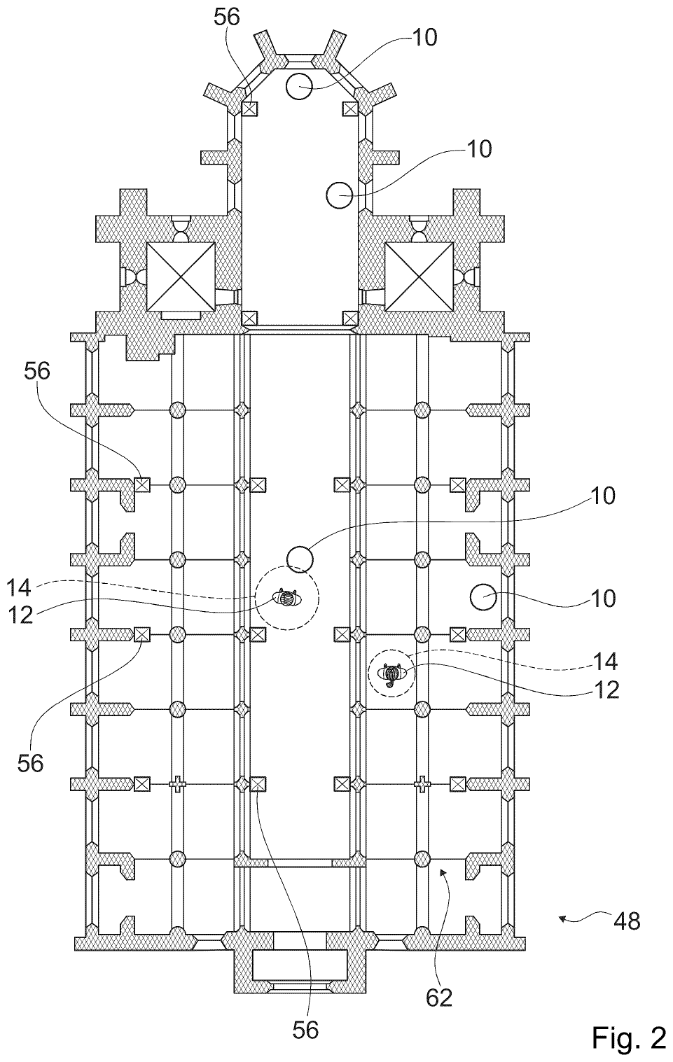

FIG. 1 shows a very simplified schematic diagram of a content management system (CMS) 48. The CMS 48 is configured for the administration of digital contents 10. The CMS 48 is configured for an addition and an output the digital contents 10 to a user 12 (see also FIG. 2). The CMS 48 is formed as a location-based CMS 48. The digital contents 10 of the location-based CMS 48 are each linked to location coordinates (see also FIG. 2). The CMS 48 is formed in a decentralized manner. The digital contents 10 of the decentralized CMS 48 are administered in a decentralized manner via a digital ledger technology (DLT) 16.

The digital contents 10 of the decentralized CMS 48 are added and output in a decentralized manner via the DLT 16. The DLT 16 is formed as a decentralized DLT 16. The DLT 16 is formed as a public DLT 16. Alternatively, the DLT 16 can also be embodied privately, at least partially in a decentralized manner and/or in a non-public manner. The DLT 16 is preferably formed as an IOTA™ tangle. In FIG. 1, however, the DLT 16 is outlined by way of example as a blockchain. The digital contents 10 of the decentralized CMS 48 can be stored in a decentralized manner, for example on the DLT 16, such as a blockchain or a tangle. Alternatively, however, the digital contents 10 can also be stored centrally on a server or on a cloud and only the administration can take place in a decentralized manner (not shown). The CMS 48 comprises a smart contract 18. The smart contract 18 is set up on the DLT 16. The smart contract 18 is configured for the administration of the digital contents 10, in particular the addition and the output of the digital contents 10. The smart contract 18 is configured for the control of play releases for the digital contents 10. The smart contract 18 is configured for the control of an integration of new digital contents 10 into the CMS 48. The smart contract 18 has one or more write functions. The smart contract 18 has one or more output functions. A DLT address of the DLT 16 is assigned to the smart contract 18. The smart contract 18 can receive DLT transactions 20. The smart contract 18 can send DLT response transactions 26 to further DLT addresses of the DLT 16. Further smart contracts 42 can be set up on the DLT 16. The further smart contracts 42 can be linked to the smart contract 18.

The CMS 48 has an interface device 22. The interface device 22 is configured for communicating with the DLT 16. The interface device 22 is configured for forming an interface between the DLT 16 and a content playback device 54 of the CMS 48, which can be assigned in particular to a user 12, and/or a content creation device 52 which can be assigned to an originator 30 of digital contents 10. In principle, it would also be conceivable for the content playback devices 54 and the content creation devices 52 to communicate with the DLT 16 directly and independently of interface devices 22, 46. The interface device 22 is permanently assigned to a user 12. The interface device 22 can be embodied, for example, as an electronic tag or as a wearable. The interface device 22 is configured for being carried along with the user 12. The CMS 48 has a localization device 50. The localization device 50 is provided for determining an instantaneous position of the user 12. The localization device 50 is configured for determining the location coordinates at which the user 12 is located. The localization device 50 is identical to the interface device 22. Alternatively, however, a separate embodiment is also conceivable. For example, the interface device 22 could receive user localizations from a third-party device, for example from a smartphone assigned to the user 12. The interface device 22 is configured for comparing the determined localizations of the user 12, in particular in real time, with virtual localizations of digital contents 10 within the CMS 48. The digital contents 10 can be embodied as augmented reality objects or as virtual reality objects. The interface device 22 is configured for informing the user 12 of digital contents 10 which are located in a region 14 of the localization of the user 12. Alternatively or additionally, the content playback devices 54 can also be configured for this task. The CMS 48 has the content playback device 54. The content playback device 54 is formed differently from the localization device 50.

The content playback device 54 is formed differently from the interface device 22. The content playback device 54 is embodied by way of example as a headphone/as VR glasses. The content playback device 54 is configured for outputting the digital contents 10 to the user 12.

The CMS 48 has the content creation device 52. The content creation device 52 is formed differently from the localization device 50. The content creation device 52 is formed differently from the interface device 22. The content creation device 52 can be identical to the content playback device 54. In the exemplary illustration of FIG. 1, however, the content creation device 52 and the content playback device 54 are formed differently and separately from one another and are assigned in particular to different users 12, 30. The CMS 48 has a further interface device 46. In the case shown in FIG. 1, the further interface device 46 is assigned to an originator 30 of digital contents 10. The further interface device 46 is formed at least substantially identically to the interface device 22. The further interface device 22 forms the localization device 50. Alternatively, however, a separate embodiment is also conceivable. The further interface device 46 is configured for communicating with the DLT 16. The further interface device 46 is configured for forming an interface between the DLT 16 and the content creation device 52, which can be assigned in particular to the originator 30. The further interface device 46 is permanently assigned to the originator 30. The further interface device 22 is configured for linking the identified localizations of the originator 30, in particular in real time, to virtual localizations of digital contents 10 which are created and left behind by the originator 30. Alternatively, however, it is also conceivable for the originator 30 to manually assign location coordinates to the digital contents 10 created by him, at which location coordinates they are then virtually located.

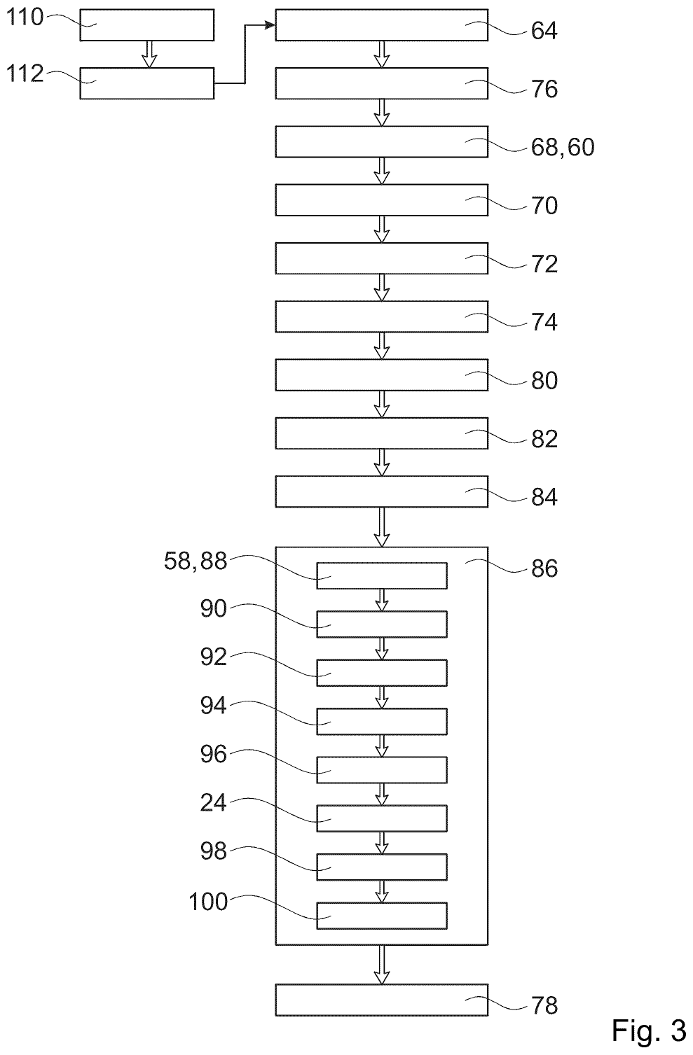

The CMS 48 can be configured for communicating and/or connecting to further parties, such as, for example, an administrator 32 of the CMS 48 and/or a producer 38 of the interface devices 22 and/or further smart contracts 42 and/or further originators 66 involved in a digital content 10. In this regard, see in particular the explanations relating to FIG. 3.

FIG. 2 shows an exemplary interior application of the CMS 48. In this case, the CMS 48 is used for a visitor guide in an interior 62 of a church (Überlinger Münster). Comparable uses at other locations on the inside (museum, fairgrounds, conference venue, hospital building, university building, airport building, etc.) such as outside (city guide, amusement park, hiking trails, etc.) are of course likewise conceivable. The CMS 48 has a plurality of anchor stations 56. The anchor stations 56 are arranged distributed within the interior 62. The anchor stations 56 are configured for a location of interface devices 22 in interiors 62. The anchor stations 56 are configured for a determination, independent of navigation satellite systems, of the location of the user 12, in particular of the interface devices 22 assigned to the user 12. The anchor stations 56 are configured for a determination, independent of navigation satellite systems, of the location of the virtually arranged digital contents 10. The anchor stations 56 are configured to enable a location by local triangulation and/or by local time-of-flight measurements. A plurality of digital contents 10 are virtually located in the interior 62. Each located digital content 10 represents, for example, an audio and/or video explanation of an object to be viewed at this location. The digital contents 10 and their positions are communicated to the user 12 by the interface devices 22. A region 14 (e.g. a circle with a radius of 2 m) is defined in each case around the user 12. The interface devices 22 continuously identify whether a digital content 10 is located in the region 14 of the user 12. If this is the case, the digital content 10 is provided for retrieval to the user 12, in particular to a content playback device 54 of the user 12, preferably via the interface device 22.

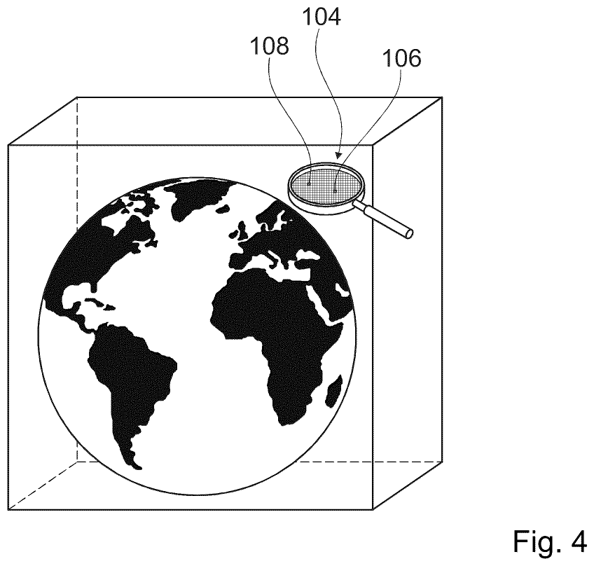

FIG. 3 shows a schematic flow diagram of a location-based content management method for outputting the digital contents 10 to the user 12. The method is formed as a decentralized content management method. The method also comprises a location-based, preferably decentralized, content management method for a spatially organized addition of digital contents 10, which are made available by the originators 30 and/or creators, in the CMS 48. In at least one method step 110, a real three-dimensional addition space 104 for digital contents 10 is divided virtually into a multiplicity of volume segments 106, 108 which are arranged next to one another and one above the other (in this respect, see also FIG. 4). The real three-dimensional addition space 104 which is shown by way of example in FIG. 4 is formed so as to span the globe. In at least one further method step 112, a bundle of bijective DLT addresses of the DLT 16 is assigned to each of the volume segments 106, 108. In this case, each of the DLT addresses assigned to the volume segments 106, 108 is assigned to precisely one time interval. In at least one further method step 64, a digital content 10 is generated by the originator 30. In this case, the originator 30 can use material (for example a background music, an animation, an image, etc.) which originates from other originators 66 (see FIG. 1). The originator 30 creates the digital content 10 by means of the content creation device 52 (for example with his smartphone). In at least one method step 76, the originator 30 assigns a location coordinate to the digital content 10. This can be carried out by searching for the location of the location coordinate and carrying out the following method step 68 at this location or by manually adding a location coordinate to the digital content 10 from another location. In this case, each participant of the CMS 48 can be an originator 30/can become active as an originator 30. In the further method step 68 which forms a submitting step 60, the originator 30 announces the desire to submit the created digital content 10. For this purpose, the originator 30 sends a DLT transaction 44 to an input function of the smart contract 18. For this purpose, the originator 30 uses the interface device 46 assigned to him. Each of the digital contents 10 added to the CMS 48 in this way is linked during the submitting to at least one of the DLT addresses assigned to one of the volume segments 106, 108. In at least one further method step 70, the smart contract 18 registers the digital content 10 in the CMS 48. For example, the smart contract 18 assigns a registration number to the digital content 10. In this case, each of the digital contents 10 is linked to the smart contract 18. In addition, the smart contract 18 assigns the originator 30 or the DLT address of the originator 30 to the digital content 10. When calling up the write function of the smart contract 18, the originator 30 optionally specifies the further digital contents which he has used in the creation of his digital content 10, or at least the DLT addresses of the originators 66 of these further digital contents.

In at least one further method step 72, the provided digital content 10 is stored in a decentralized manner in the DLT 16. Alternatively, a central storage or a cloud storage is also conceivable. In at least one further method step 74, the provided digital content 10 is linked by the smart contract 18 to a non-fungible token (NFT) of the DLT 16. This can be done, for example, by an addition of a hash value of the digital content 10 in an NFT of the DLT 16. There may be a plurality of NFTs for each digital content 10, with the result that each user 12 receives an individual, distinctive and non-duplicatable NFT of the digital content 10. In at least one further method step 80, the digital content 10 is provided for location-based retrieval at the linked coordinates after the submitting in the CMS 48.

In at least one further method step 82, a location of the user 12 is determined. For this purpose, the localization device 50 of the user 12 determines the continuously changing position of the mobile user 12 in the interior 62. The position is determined via an interaction with the anchor stations 56. In this case, the interface devices 22 exchange signals with the anchor stations 56 or receive signals from the anchor stations 56, on the basis of which the position can be determined. In at least one further method step 84, it is determined whether a digital content 10 is virtually arranged in the region 14 around the location of the user 12. If a digital content 10 is determined in the region 14, it is provided for retrieval to the user 12 in a further method step 86. The digital content 10 is provided in the method step 86 via the smart contract 18. The user 12 can additionally also use the localization device 50 for compiling and/or navigating a guided tour. In this case, it is conceivable that it can be selected between different tours passing different digital contents 10. If a plurality of digital contents 10 are identified in the region 14 around the location of the user 12, for example, a display of a drop-down menu can be configured within the content playback device 54, by means of which a digital content 10 can be easily selected from among a plurality of contents.

In at least one substep 88 of the method step 86 which forms a request step 58, the user 12 announces a desire to retrieve the digital content 10. For this purpose, the user 12 sends a DLT transaction 20 to an input function of the smart contract 18. With regard to a further illustration of all DLT transactions described below, reference is also made to FIG. 1 at this point. This takes place by means of the interface device 22 assigned to the user 12. In this case, the DLT transaction 20 comprises call parameters for the input function of the smart contract 18. In addition, at least one digital asset, such as e.g. a DLT token, is appended to the DLT transaction 20 to the input function. It is conceivable for the interface devices 22 to be connectable to a cryptowallet of a user 12 or for separate cryptowallets to be assigned to the interface devices 22, which cryptowallets can be loaded with digital assets by the user 12, for example by a fiat payment to the administrator 32 when the respective interface devices 22 are taken over. In at least one further substep 90 of the method step 86, the smart contract 18 is executed by at least one DLT node of the DLT 16. In at least one further substep 92 of the method step 86, a release of the digital content 10 is at least triggered by a DLT response transaction 26 of the smart contract 18. In this case, the digital content 10 is released specifically for at least one interface device 22 to which a DLT receive address of the DLT response transaction 26 is assigned or to which a DLT address is assigned which is specified in the DLT response transaction 26.

In at least one further substep 94 of the method step 86, the DLT response transaction 26 is flanked by a first DLT response accompanying transaction 28. The DLT response accompanying transaction 28 is sent by the smart contract 18 in temporal relationship (at the same time or shortly before or shortly after) to the DLT response transaction 26. The DLT response accompanying transaction 28 comprises sending at least one digital asset/forwarding at least a part of the digital asset which was appended to the DLT transaction 20 by the user 12 (in the substep 88). The DLT response accompanying transaction 28 is sent by the smart contract 18 to a third-party DLT address not assigned to the user 12 with the desire to retrieve. The third-party DLT address to which the DLT response accompanying transaction 28 is directed is assigned to the originator 30 of the digital content 10. For example, 75% of the digital assets appended to the DLT transaction 20 by the user 12 are assigned to the originator 30. In at least one further substep 96 of the method step 86, the DLT response transaction 26 is flanked by a second DLT response accompanying transaction 34. The second DLT response accompanying transaction 34 is sent by the smart contract 18 in temporal relationship (at the same time or shortly before or shortly after) to the DLT response transaction 26. The second DLT response accompanying transaction 34 comprises sending at least one digital asset/forwarding at least a part of the digital asset which was appended to the DLT transaction 20 by the user 12 (in the substep 88). The second DLT response accompanying transaction 34 is sent by the smart contract 18 to a third-party DLT address not assigned to the user 12 with the desire to retrieve. The third-party DLT address to which the second DLT response accompanying transaction 34 is directed is assigned to the administrator 32 and/or a provider of the digital content 10. For example, 10% of the digital assets appended to the DLT transaction 20 by the user 12 are assigned to the administrator 32 and/or the provider of the digital content 10. In at least one further substep 24 of the method step 86, the DLT response transaction 26 is flanked by a third DLT response accompanying transaction 36. The third DLT response accompanying transaction 36 is sent by the smart contract 18 in temporal relationship (at the same time or shortly before or shortly after) to the DLT response transaction 26. The third DLT response accompanying transaction 36 comprises sending at least one digital asset/forwarding at least a part of the digital asset which was appended to the DLT transaction 20 by the user 12 (in the substep 88). The third DLT response accompanying transaction 36 is sent by the smart contract 18 to a third-party DLT address not assigned to the user 12 with the desire to retrieve. The third-party DLT address to which the third DLT response accompanying transaction 36 is directed is assigned to an owner and/or the producer 38 of the interface device 22 assigned to the user 12. For example, 15% of the digital assets appended to the DLT transaction 20 by the user 12 are assigned to the owner and/or the producer 38 of the interface device 22 assigned to the user 12.

In at least one further substep 98 of the method step 86, the DLT response transaction 26 is flanked by a fourth DLT response accompanying transaction 40.

The fourth DLT response accompanying transaction 40 is sent by the smart contract 18 in temporal relationship (at the same time or shortly before or shortly after) to the DLT response transaction 26. The fourth DLT response accompanying transaction 40 comprises sending at least one digital asset/forwarding at least a part of the digital asset which was appended to the DLT transaction 20 by the user 12 (in the substep 88). The fourth DLT response accompanying transaction 40 is sent by the smart contract 18 to a third-party DLT address not assigned to the user 12 with the desire to retrieve. The third-party DLT address to which the fourth DLT response accompanying transaction 36 is directed is assigned to the further smart contract 42. As a result, the smart contract 18 is linked to the further smart contract 42. The further smart contract 42 can be configured for the organization/administration of a further digital content. The further smart contract 42 can be configured for the allocation of royalties. In at least one further substep 100 of the method step 86, an input function of the further smart contract 42 is executed triggered by the fourth DLT response accompanying transaction 40. Further DLT response accompanying transactions 102 are triggered by the further smart contract 42 in response to the execution of the input function. At least parts of the digital assets which were sent to the further smart contract 42 with the fourth DLT response accompanying transaction 40 are each appended to the further DLT response accompanying transactions 102. For example, one of the recipients of the further DLT response accompanying transactions 102 is the further originator 66, the material of whom was used in the originally requested digital content 10. For example, one of the recipients of the further DLT response accompanying transactions 102 is the administrator 32 via whom the further digital content which was reused in the creation of the originally requested digital content 10 was provided. For example, 10% of the 75% of the originator 30 are assigned to the further originator 66. For example, 5% of the 75% of the originator 30 are assigned to the administrator 32 via whom the further digital content was provided. In general, the number of DLT response accompanying transactions 28, 34, 36, 40, 102 which flank a DLT response transaction 26 or which are triggered by a DLT response transaction 26 can be changed as desired. A linking of a plurality of further smart contracts 42 to the smart contract or else a chain of linked smart contracts 18, 42 is also conceivable.

In at least one further method step 78, the released digital content 10 is played by the user 12 by means of the content playback device 54. For this purpose, only the release or else the entire digital content 10 can be forwarded from the interface device 22 to the content playback device 54.

1. A location-based, preferably decentralized, content management method at least for outputting digital contents to a user, comprising at least the method steps
determining a location of the user
identifying a digital content virtually arranged in the region of the location of the user
providing the digital content for retrieval to the user,
wherein the digital content is provided via at least one smart contract set up on a, preferably decentralized, digital ledger technology (DLT), such as e.g. a blockchain or a tangle.

2. The method according to claim 1, wherein a desire to retrieve the digital content is announced by sending a DLT transaction to a write function of the smart contract, in particular by means of an interface device assigned to the user.

3. The method according to claim 2, wherein at least one digital asset, such as e.g. a message, information or a DLT token, is appended to the DLT transaction for the write function, in particular in addition to the call parameters for the write function.

4. The method according to claim 2, wherein a release of the digital content is at least triggered by a DLT response transaction of the smart contract.

5. The method according to claim 4, wherein the digital content is released specifically for at least one interface device to which a DLT receive address of the DLT response transaction is assigned or to which a DLT address is assigned which is specified in the DLT response transaction.

6. The method according to claim 4, wherein the DLT response transaction is flanked by at least one DLT response accompanying transaction, in particular of the smart contract, which comprises at least sending at least one digital asset, such as e.g. a message, an information or a DLT token, to at least one third-party DLT address, in particular not assigned to the user with the desire to retrieve.

7. The method according to claim 6, wherein at least one third-party DLT address which is the target of at least one DLT response accompanying transaction is assigned to an originator of at least a part of the digital content.

8. The method according to claim 6, wherein at least one third-party DLT address which is the target of at least one DLT response accompanying transaction is assigned to an administrator and/or provider of the digital content.

9. The method according to claim 6, wherein at least one third-party DLT address which is the target of at least one DLT response accompanying transaction is assigned to an owner and/or producer of the interface devices which can be assigned to the users.

10. The method according to claim 6, wherein at least one third-party DLT address which is the target of at least one DLT response accompanying transaction is assigned to at least one further smart contract.

11. The method according to claim 10, wherein a write function of the further smart contract is executed by the DLT response accompanying transaction.

12. The method according to claim 1, wherein a desire to submit a digital content which is provided for retrieval, in particular after the submitting, is announced by sending a DLT transaction to a further write function of the smart contract, in particular by means of an interface device assigned to an originator and/or a submitter.

13. The method according to claim 1, wherein the provided digital contents are linked to a non-fungible token (NFT) of the DLT.

14. The method according to claim 1, wherein at least some of the provided digital contents are stored in a decentralized manner, for example in the DLT.

15. A location-based, preferably decentralized, content management method at least for a spatially organized addition of digital contents which are made available by originators and/or creators in a location-based, in particular decentralized, content management system, wherein a real three-dimensional addition space for digital contents is divided virtually into a multiplicity of volume segments which are arranged next to one another and one above the other,
wherein each of the volume segments is assigned a bijective DLT address of a, preferably decentralized, digital ledger technology (DLT), such as e.g. a blockchain or a tangle, and
wherein each of the digital contents is linked during the submitting to at least one of the DLT addresses assigned to one of the volume segments.

16. The method according to claim 15, wherein each of the digital contents is linked to at least one smart contract set up on the DLT, wherein the digital content is provided to users via the at least one smart contract, preferably by means of a method according to claim 1.

17. The method according to claim 15, wherein the real three-dimensional addition space is formed so as to span the globe.

18. The method according to claim 15, wherein the DLT addresses assigned to the volume segments are additionally assigned to time intervals.

19. A location-based, in particular decentralized, content management system (CMS), for carrying out a method according to claim 1.

20. The CMS according to claim 19, having at least one localization device for determining an instantaneous position of the user of the localization device and at least one interface device for communicating with the DLT.

21. The CMS according to claim 20, further comprising a content creation device which is formed differently from the localization device and differently from the interface device.

22. The CMS according to claim 20, further comprising a content playback device which is formed differently from the localization device and differently from the interface device.

23. The CMS according to claim 21, further comprising a content playback device which is formed differently from the localization device and differently from the interface device, and wherein the content creation device is identical to the content playback device.

24. The CMS according to claim 20, wherein the localization device is identical to the interface device.

25. The CMS according to claim 20, further comprising one or more anchor stations which enable a determination, independent of navigation satellite systems, of a location of the user and/or of the virtually arranged digital contents, e.g. by local triangulation or by local time-of-flight measurements.
